(19) United States
(12) Patent Application Publication
(10) Pub. No.: US 2016/0214274 A1
(43) Pub. Date: Jul. 28, 2016

(54) Reinforced Mold For Casting Concrete Blocks

(71) Applicant: Rosetta Hardscapes, LLC, Charlevoix, MI (US)

(72) Inventor: Joshua S. Manthei, Petoskey, MI (US)

(73) Assignee: Rosetta Hardscapes, LLC, Charlevoix, MI (US)

(21) Appl. No.: 15/005,901

(22) Filed: Jan. 25, 2016

Related U.S. Application Data
(60) Provisional application No. 62/107,975, filed on Jan. 26, 2015.

(51) Int. Cl. B28B 7/06; B28B 1/14; B28B 7/00

(52) U.S. Cl. CPC B28B 7/06; B28B 7/0029; B28B 1/14

(57) ABSTRACT

A resilient mold including a plurality of cavities in which a plurality of concrete blocks are cast. Cured concrete blocks are demolded from the mold by supporting the inverted mold on a support surface, engaging two opposing edges of the mold and separating the mold from the support surface so that the mold bends or sags to release the blocks from the mold cavities. The mold includes at least one wall extending in a direction between the two opposing edges between two adjacent mold cavities. One or more resilient support rods is embedded in the wall. The support rods are shaped to bend in a first direction while resisting bending in a direction perpendicular to the first direction. The rods are oriented in the wall for preventing the wall from deforming as the adjacent mold cavities are filled with concrete, while permitting the wall to bend during demolding.

### STATEMENT REGARDING FEDERALLY SPONSORED RESEARCH OR DEVELOPMENT

Not Applicable.

### TECHNICAL FIELD

The invention relates to a mold for casting concrete blocks.

### BACKGROUND OF THE INVENTION

Concrete blocks have been cast in resilient molds formed, for example, from polyurethane. The molds have an open top in which the liquid concrete is poured. After the concrete has sufficiently cured, the cast block is demolded by inverting the mold. The inverted mold is on a pallet or other support surface which will receive the demolded blocks. In some cases, the blocks are not easily demolded due to surface shapes and textures. One process for demolding the blocks involves engaging opposite edges of the inverted mold and separating the mold from a support surface. The weight of the blocks causes the mold to sag and stretch sufficiently to allow the blocks to fall from the mold onto the support surface. After the cured blocks are demolded, the mold is turned upright and ready for casting additional blocks.

A mold may have a number of cells or cavities for simultaneously casting a number of blocks. The cells are filled with concrete either one at a time or a row at a time. If the wall between adjacent cells is too small, the cell wall between a cell being filled and an adjacent empty cell may bend or deflect into the empty cell, causing a deformities in blocks cast in the deformed cells.

### BRIEF SUMMARY OF THE INVENTION

According to the invention, the risk of producing deformed concrete blocks cast in a multi cell resilient mold is reduced by incorporating elongated support or reinforcement members in the mold walls. The reinforcement members are formed from a resilient material such as graphite spring steel. The rods are shaped and of a size which will minimize mold wall deformity as the mold cells are filled with concrete, while permitting the mold to flex or sag as the hardened concrete blocks are released from an inverted mold.

Various objects and advantages of the invention will become apparent from the following detailed description of the invention and the accompanying drawings.

### BRIEF DESCRIPTION OF THE DRAWINGS

FIG. 1 is a top plan view of an exemplary prior art mold for casting 8 concrete blocks, showing deflection of side walls of two cells or cavities;

FIG. 2 is a side elevational view of a mold during demolding of cured cast blocks;

FIG. 3 is a perspective view of a reinforced mold according to the invention for casting 9 concrete blocks;

FIG. 4 is a an end perspective view of the mold of FIG. 3;

FIG. 5 is a side cross sectional view of the mold as taken along line 5-5 of FIG. 4; and

FIG. 6 is a fragmentary perspective view of the reinforcement member embedded in the mold of FIG. 3.

### DETAILED DESCRIPTION OF THE INVENTION

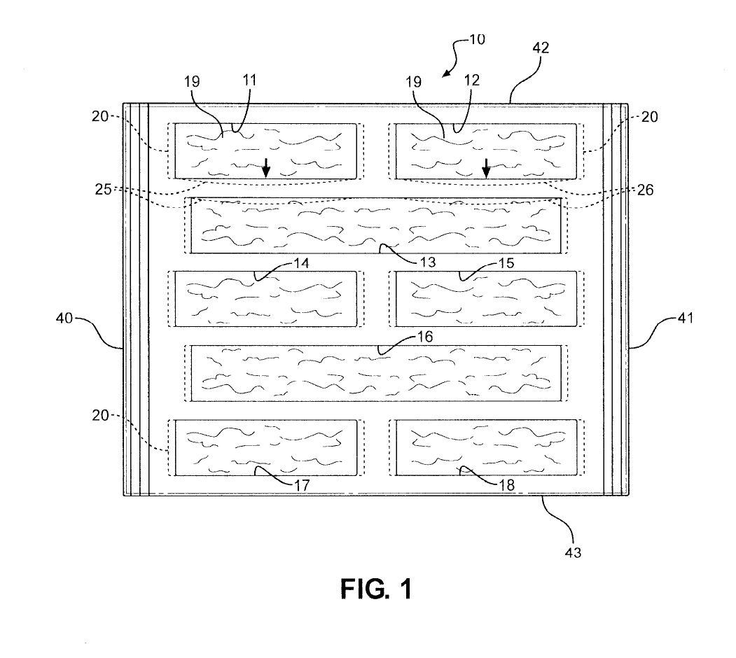

Referring to FIG. 1 of the drawings, a top view of an exemplary prior art mold 10 is shown. The mold 10 is formed from a tough, resilient material which will withstand repeated use for casting concrete blocks, such as polyurethane. In the illustrated mold 10, 8 cells or cavities 11-18 are shown for simultaneously casting 8 blocks. During casting, the bottom of the mold is typically supported on a rigid support surface, such as a steel plate, and the exterior sides of the mold may be supported by a rigid frame (not shown). Bottom surfaces 19 of the cavities 11-18 may be textured to form textured faces on blocks cast therein. Depending on the intended application for blocks cast in the mold 10, the cast blocks may have rectangular shapes, having parallel sides and parallel ends, or ends of the blocks may be angled where, when viewed from the top, the blocks will have a trapezoid shape with the textured face of each block being wider than the back of the block. When the blocks have angled ends, the angled ends of the cavities 11-18 are arranged in the mold 10 to face the mold sides 22 and 23 to facilitate demolding. The angled sides permit the blocks to be arranged side-by-side forming either a straight wall or a curved wall with the faces of adjacent blocks abutting. Since the textured faces of the blocks are formed at the bottom of the cells or mold cavities and they are wider than the backs of the blocks which are formed at the open tops of the cavities 11-18, they are more difficult to the cured blocks demold. The broken lines 20 in FIG. 1 show extended ends of the faces 19, forming longer block faces than the width of the backs of the blocks.

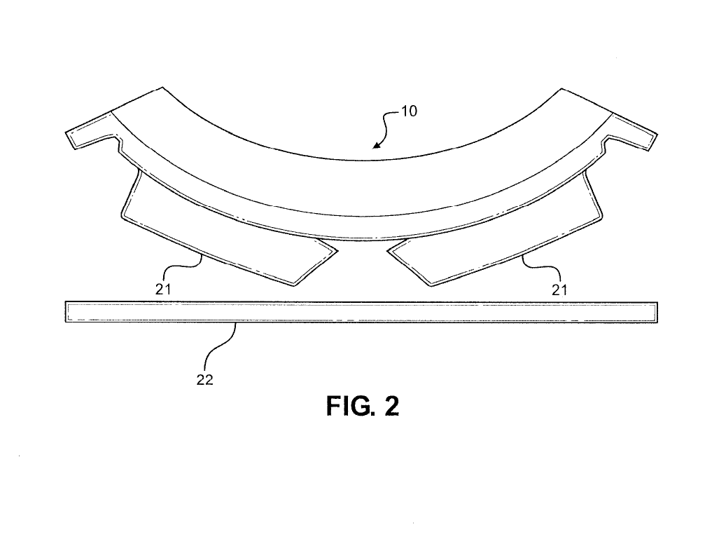

One known method for demolding block cast in the mold 10, as shown in FIG. 2, involves placing a support surface 22 on top of the mold, and then inverting the mold 10 and blocks 21 and the support surface 22, engaging two opposite edges 23, 24 of the mold and raising the mold above a support surface, either by lifting the mold 10 or by lowering the support surface. As the mold 10 is separated from the support surface 22, the resilient mold 10 will sag and stretch to allow the blocks 20 to fall onto the support surface. For blocks 21 which are difficult to demold, pressure may be placed on the inverted bottom of the mold to help push the blocks from the mold. For ease of demolding, the resilient mold 10 must have sufficient resiliency to allow the mold 10 to sag with the help of the weight of the blocks 20 and release the cast blocks during the demolding step. This process is shown, for example, in U.S. Pat. No. 8,968,623 entitled Process And Apparatus For Demolding And Palletizing Cast Concrete Blocks, the disclosure of which is incorporated herein.

Referring again to FIG. 1, it should be appreciated that the mold cells or cavities 11-18 will are normally not be simultaneously filled with concrete at the same rate. The cavities 11 and 12, for example, may be filled with concrete prior to filling the cavity 13 with concrete. Due to the resiliency of the mold 10, the weight of the concrete in the cavity 11 can cause the wall between cavity 11 and cavity 13 to bulge or deflect into the cavity 13, as shown by the dashed lines 25. Similarly, the weight of the concrete in the cavity 12 can cause the wall between cavity 12 and cavity 13 to bulge or deflect into the cavity 13, as shown by the dashed lines 26. The bulging will cause deformities in the blocks cast in the cavities 11, 12 and 13. Problems with the cavity walls deforming can be reduced by designing the mold with thicker walls between adjacent mold cavities. However, this will reduce the number of blocks that can be cast in a mold, unless the mold is made larger. This will add to the cost for casting concrete blocks.

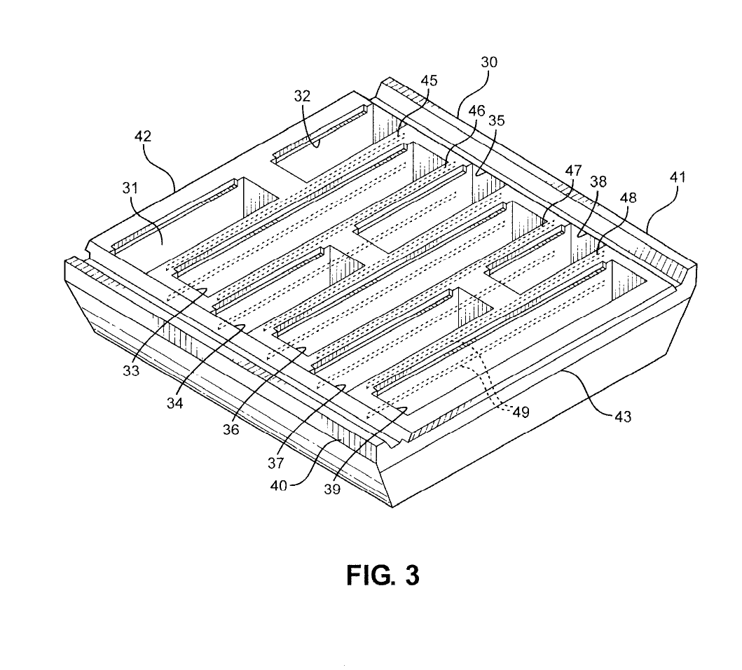

FIGS. 3-5 show details of a mold 30 constructed according to the invention for casting a plurality of concrete blocks. The mold 30 will have at least 2 cavities, with 9 cells or cavities 31-39 shown in the exemplary mold 30. The multiple cavities may be of the same size or of different sizes, as shown in the exemplary mold. The cavities are arranged in the mold for efficient use of the space. The illustrated mold 30 is rectangular when viewed from the top and has opposing sides 40 and 41 and opposing sides 42 and 43. The block cavities extend either singly or in rows with the longitudinal directions extending between the sides 40 and 41. Shorter block cavities 31 and 32, for example, are aligned in a row which is parallel to the longer cavity 33. A mold wall 45 extends between the larger cavity 33 and the smaller cavities 31 and 32.

Prior to demolding cured concrete blocks from the mold 30, a support surface such as a rigid steel plate, is placed over the top of the mold 30 to cover the openings to the cavities 31-39 and the mold 30 and the support surface are inverted together so that the cured blocks rest on the support surface. During demolding of cured blocks from the mold 30, the opposing mold sides 43 and 44 are gripped by the demolding machine, such as is shown in U.S. Pat. No. 8,968,623. The mold 20 and the mold 30 and/or the support surface are moved apart. The weight of the blocks cause the mold to sag, allowing the blocks to fall from the mold onto the support surface. If necessary, pressure may be applied to the upper surface of the inverted mold to help push the blocks from the mold.

In the illustrated mold 30, five walls 44-48 extend between the mold sides 42 and 43 in addition to the mold sides 40 and 41. One side of the cavities 31 and 32 is formed by the mold side 40 and the wall 44 forms an opposite side to the cavities 31 and 32. The cavities 33 and 34 are located between the walls 44 and 45. The cavity 35 is located between the walls 45 and 46. The cavity 36 is located between the walls 46 and 47. The cavities 37 and 38 are located between the walls 47 and 48, and the cavity 39 is located between the wall 48 and the mold side 41.

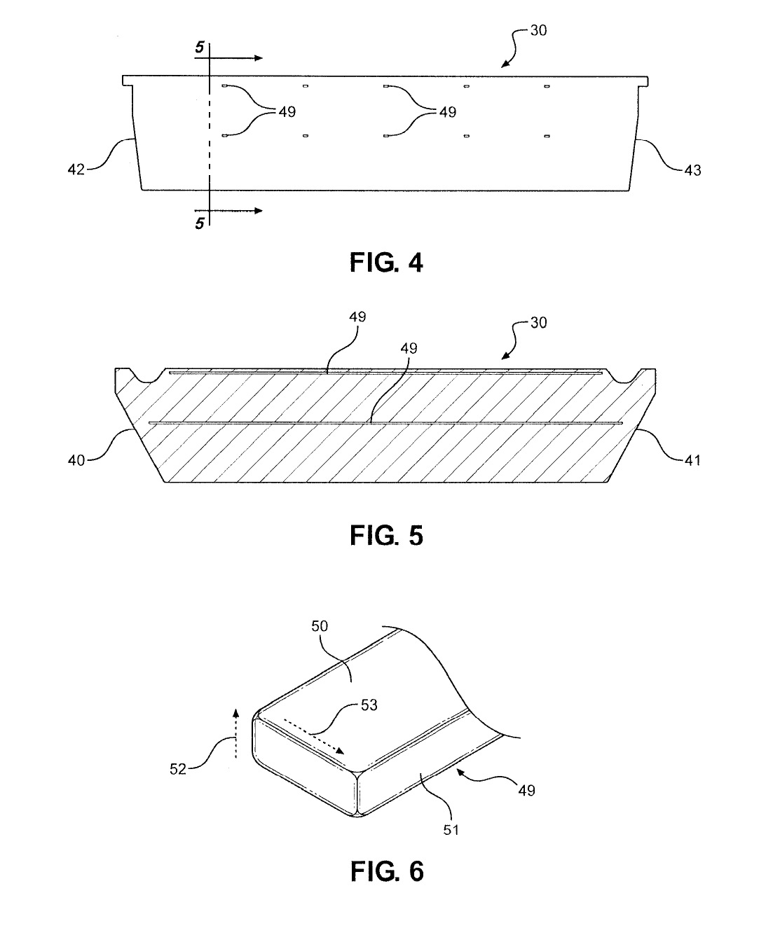

According to the invention, one or more elongated reinforcement members or rods 49 are illustrated embedded in mold walls 44-48. If the mold sides 40 and 41 are subject to deforming as the adjacent mold cavities are filled with concrete, one or more rods 49 also may be embedded in these mold sides. If the mold sides 40 and 41 are supported by a rigid frame during the casting and curing process, these optional rods may be omitted. In FIGS. 4 and 5, two of the rods 49 are shown embedded in each of the walls 44-48. However, only a single support rod 49 or more than two support rods 46 may be used, depending on the dimensions of the mold 30 and the amount of support needed. Preferably, the rods 49 are completely embedded in the mold 30 and do not extend to the walls 42 and 43.

The support rods 49 are formed from a resilient material, such as carbon fiber or a spring steel, and are elongated and are shaped in cross section to resist bending in one direction and to be more flexible when bent in a perpendicular direction. This may be achieved, for example, by constructing the support rod 49 to be relatively flat with a rectangular cross section, as shown in FIG. 6, with a wide side 50 and a short side 51. Optionally, corners between adjacent sides 50 and 51 may be rounded as shown in FIG. 6. to reduce the risk of sharp corners inducing tears in the adjacent mold 30 when the mold bends during the demolding process. The support rods 49 will easily bend in the direction of the arrow 52 and will resist bending in a perpendicular direction shown by the arrow 53. The flat support rods 49 are embedded in the mold 30 with the flat sides parallel to a top surface 50 and a bottom surface 51. In this arrangement, the support rods 49 do not inhibit bending and sagging of the inverted mold 30 during demolding. However, when a mold cell is filled with concrete, the support rods 49 restrict the mold walls 44-48 from deforming as the cavities are individually filled with concrete. The support rods 49 permit construction of the mold 30 with thinner walls between adjacent block forming cavities, which in turn permits forming more block cavities for the same size mold, which in turn reduces the cost of manufacturing blocks and increases the output of cast blocks.

It will be appreciated that various modifications and changes may be made to the above described preferred embodiment of a mold for casting concrete blocks without departing from the scope of the following claims. For example, the reinforcement rods may be replaced with other types of members which are rigid in one direction while bending with minimal resistance in a 90 degree direction, such as, for example, a roller chain similar to a bicycle chain which is quite flexible in one direction while stiff in a 90 degree direction, or a tough flexible fabric having short rigid parallel rods embedded therein.

1. A mold for simultaneously casting a plurality of concrete blocks comprising a resilient mold having first and second opposing sides, at least two adjacent cavities formed in the mold for simultaneously casting at least two blocks, the mold having a wall extending between the two cavities and extending in a direction between the first and second sides, at least one elongated reinforcement member embedded in the wall to extend between the two cavities in a direction between the two sides, and wherein the reinforcement member is configured to resist bending in of the wall in a first direction extending between the two cavities while having reduced resistance to bending of the wall in a second direction perpendicular to the first direction.

2. The mold of claim 1, and wherein the reinforcement member is an elongated rod.

3. The mold of claim 2, and wherein at the reinforcement rods are formed from a material selected from a group consisting of steel and carbon fiber.

4. The mold of claim 2, and wherein the elongated rod has a generally rectangular cross section with a wide side extending in the first direction and a narrow side extending in the second direction.

5. The mold of claim 4, and wherein the mold is generally rectangular having third and fourth sides extending between the first and second sides, wherein the third side abuts a side to at least one of the cavities and the fourth side abuts a side to a different one of the cavities, and wherein at least one reinforcement rod is embedded in the third side and at least one reinforcement rod is embedded in the fourth side wherein the rods extend in a direction extending between the first and second sides with the flat sides of each of the rods extending in the first direction and the narrow sides of each of the rods extending in the second direction.

6. The mold of claim 5, and wherein at the reinforcement rods are formed from a material selected from a group consisting of steel and carbon fiber.
